(19) United States
(12) Patent Application Publication
(10) Pub. No.: US 2008/0171264 A1
(43) Pub. Date: Jul. 17, 2008

(54) Nonaqueous electrolyte secondary battery and fabrication method thereof

(76) Inventors: Masanobu Takeuchi, Moriguchi-city (JP); Hiroyuki Fujimoto, Moriguchi-city (JP); Seiji Yoshimura, Hirataka-city (JP); Ikuro Nakane, Moriguchi-city (JP)

Correspondence Address: KUBOVCIK & KUBOVCIK, SUITE 1105, 1215 SOUTH CLARK STREET, ARLINGTON, VA, 22202, US

(21) Appl. No.: 12/007,791

(22) Filed: Jan. 15, 2008

(30) Foreign Application Priority Data
Jan. 16, 2007 (JP) 2007-007140

(51) Int. Cl. H01M 4/48

(52) U.S. Cl. 429/231.1; 252/182.1

(57) ABSTRACT

A nonaqueous electrolyte secondary battery including a positive electrode containing a positive active material, a negative electrode containing a negative active material and a nonaqueous electrolyte. The secondary battery contains, as the negative active material, a lithium-containing molybdenum oxide represented by a chemical formula LiₓMoO₂ (0.05≦x≦0.25) when in a fully discharged state. The lithium-containing molybdenum oxide can be obtained by allowing lithium to react to molybdenum dioxide (MoO₂) electrochemically, for example.

### BACKGROUND OF THE INVENTION

1. Technical Field

The present invention relates to a nonaqueous electrolyte secondary battery suitable for use as a secondary battery for backing up a memory and a fabrication method thereof.

2. Description of Related Art

Recent years have seen a widespread use of nonaqueous electrolyte secondary batteries using nonaqueous electrolyte solutions as high-power and high-energy secondary batteries. Such nonaqueous electrolyte secondary batteries are used not only as a main power source for mobile devices but also as a memory backup battery for mobile devices. The recent increase in energy density of main power sources for mobile devices also requires increase in energy density of memory backup power sources.

As a memory backup secondary battery, a battery using lithium cobaltate (LiCoO₂) as a positive active material and spinel-type lithium titanate (Li₄Ti₅O₁₂) as a negative active material has been already put to practical use, for example. However, the theoretical density and gravimetric capacity of lithium titanate for use as the negative active material are 3.47 g/ml and 175 mAh/g, respectively, and its low volumetric energy density has been a problem. Molybdenum dioxide having a rutile structure reversibly reacts with lithium in the same potential range as lithium titanate. Its theoretical density and gravimetric capacity are 6.44 g/ml and 210 mAh/g and its volumetric energy density is higher than that of lithium titanate. Accordingly, the use of molybdenum dioxide as a substituent of lithium titanate increases a volumetric energy density of a battery.

For example, Japanese Patent Laid-Open No. 2000-243454 proposes a battery which uses lithium cobaltate as a positive active material and molybdenum dioxide as a negative active material.

A memory backup secondary battery is mounted as a battery for incorporation in a device and is used without a protection circuit in view of mounting area and cost. Accordingly, if a current supply from a main power source is discontinued over an extended period of time, the battery is presumed to be in an over discharged state. It is therefore required that a decline in capacity of the battery is small even if it is cycled on over discharge.

As described above, molybdenum dioxide is superior in volumetric energy density to lithium titanate. However, after an intensive study conducted by inventors of this application, it has been found that the nonaqueous electrolyte secondary battery using lithium cobaltate as the positive active material and molybdenum dioxide as the negative active material exhibits a rapidly declining capacity with cycling on over discharge to problematically result in the failure to obtain sufficient cycle characteristics.

It is an object of the present invention to provide a nonaqueous electrolyte secondary battery which shows superior cycle characteristics on over discharge and a method for fabrication thereof.

### SUMMARY OF THE INVENTION

The nonaqueous electrolyte secondary battery of the present invention includes a positive electrode containing a lithium-containing transition metal oxide as a positive active material, a negative electrode containing a negative active material and a nonaqueous electrolyte. Characteristically, the negative active material comprises a lithium-containing molybdenum oxide represented by the chemical formula LiₓMoO₂ (0.05≦x≦0.25) when in a fully discharged state.

Most lithium transition metal oxides, including lithium cobaltate, provide an initial charge/discharge efficiency in the approximate range of 90-95%. However, in the case where molybdenum dioxide is used as the negative active material, the initial efficiency of the battery is limited to the approximate range of 80-85%. This is presumably because, if a lithium concentration of the molybdenum dioxide drops in a final stage of discharging, load characteristics of the negative electrode deteriorate to increase a potential of the negative electrode so that the initial charge/discharge efficiency of the battery drops.

If the battery is discharged to a voltage of not higher than 0.5 V (more strictly not higher than 0.1 V), the potential of the negative electrode further increases and the lithium concentration in the negative electrode approaches 0. When the lithium concentration in the negative electrode decreases to nearly 0, molybdenum dioxide becomes extremely unstable in the electrolyte so that dissolution of molybdenum (Mo) into the electrolyte occurs, as has been ascertained by the inventors of this application (see below-described Reference Examples). After dissolution into the electrolyte, molybdenum is presumed to deposit or precipitate on a surface of the positive or negative electrode and disturb storage/release of lithium so that a capacity decline occurs with cycling on over discharge.

On the other hand, it has been ascertained that molybdenum dioxide while storing lithium stays stably in the electrolyte so that dissolution of molybdenum hardly occurs (see below-described Reference Example).

In the present invention, used as the negative active material is a lithium-containing molybdenum oxide represented by the above-specified chemical formula in the fully discharged state. Accordingly, even in the fully discharge state where a battery voltage falls below 0.5 V (more strictly below 0.1 V), the high lithium concentration of the molybdenum dioxide is sustained. This greatly reduces the occurrence of potential buildup and prevents dissolution of molybdenum. Therefore, the present invention can suppress dissolution of molybdenum into the electrolyte and prevent decline of a capacity due to cycling on over discharge.

In the present invention, the fully discharged state refers to a condition where a battery has been discharged to a voltage of not higher than 0.5 V (more strictly not higher than 0.1 V), as described above. It follows that the lithium-containing molybdenum oxide is merely required to have a composition represented by the above chemical formula after the battery is discharged to a voltage of not higher than 0.5 V (more strictly not higher than 0.1 V). It is more preferred that x in the above chemical formula is in the range of 0.10≦x≦0.20.

In the present invention, the lithium-containing molybdenum oxide preferably has a composition represented by the above chemical formula immediately after the battery is assembled. More preferably, x in the chemical formula is in the range of 0.10≦x≦0.20.

As described above, the lower initial charge/discharge efficiency of the battery than that of the positive electrode is believed due to the increase in potential of the negative electrode that results from the concentration decline of lithium present therein. In order to suppress increase in potential of the negative electrode in the final stage of over discharge, at least 5% in amount of lithium that can be stored in molybdenum dioxide (MoO₂) must be allowed to remain in the negative electrode when the battery is in the fully discharged state, as specified by 0.05≦x. However, in actual use, lithium is partly inactivated as a result of charge-discharge cycling and change with time, which gives rise to a phenomenon of destroying a balance of the positive and negative electrodes. Accordingly, it is more preferred that at least 10% in amount of lithium that can be stored in molybdenum dioxide is-allowed to remain in the negative electrode even when the battery is in the fully discharged state, as given by 0.10≦x.

In a normal charge-discharge reaction, lithium remaining in the form of LiₓMoO₂ in the fully discharged state does not participate in the charge-discharge reaction. In a limited interior volume of a battery, this leads to a capacity decline of the battery. Accordingly, the amount of lithium allowed to remain in the negative electrode when the battery is in the fully discharged state is preferably not higher than 25%, more preferably not higher than 20%, in amount of lithium that can be stored in molybdenum dioxide.

The lithium-containing molybdenum oxide represented by the above chemical formula in the present invention can be obtained, for example, by allowing lithium to electrochemically react to molybdenum dioxide (MoO₂). Specifically, a negative active material layer containing molybdenum dioxide (MoO₂) is first formed. Then metallic lithium is placed in such a position as to contact the negative active material layer. The negative active material layer and metallic lithium while in such an arrangement are brought into contact with a nonaqueous electrolyte to thereby allow lithium to react to molybdenum dioxide (MoO₂) electrochemically. In assembling a battery, subsequent to formation of the negative active material layer containing molybdenum dioxide (MoO₂), a nonaqueous electrolyte is poured into a battery incorporating a positive electrode, a negative electrode and metallic lithium in positions to thereby allow lithium to react to molybdenum dioxide.

Metallic lithium is placed in any position, so long as it contacts the negative active material layer containing molybdenum dioxide. However, in the case where the negative electrode includes a current collector, metallic lithium is preferably placed between the negative active material layer and the current collector. This is because insertion of lithium ions in a charge-discharge reaction tends to start from a surface portion of the negative electrode that has a shorter transfer distance to the positive electrode and, as a result, creates a concentration gradient of lithium in the negative electrode. That is, a lithium concentration of the negative electrode is extremely lowered in the neighborhood of the current collector, where a lithium concentration of molybdenum dioxide also becomes extremely low, as described above, so that the tendency of molybdenum to dissolve into the electrolyte increases. Interposition of metallic lithium between the negative active material layer and the current collector increases a lithium concentration of the negative electrode in the neighborhood of the current collector in advance of the charge-discharge reaction. This previous increase of lithium concentration compensates for the concentration decline of lithium that occurs in the neighborhood of the current collector during the charge-discharge reaction, so that the concentration gradient of lithium in the negative electrode as a whole is eased to restrain molybdenum from dissolving into the electrolyte.

The presence of the concentration gradient of lithium in the negative electrode during storage at high temperature causes dissolution of molybdenum from the negative electrode starting from its portion lower in lithium concentration and accordingly increases an internal resistance of the battery. The placement of metallic lithium between the negative active material layer and the current collector eases the gradient of lithium concentration and retards dissolution of molybdenum, as described above. This suppresses build-up of internal resistance of the battery during storage at high temperature and accordingly improves its storage characteristics.

The above-described gradient of lithium concentration in the negative electrode becomes steeper with an increasing thickness of the negative electrode, because the increased thickness extends a migration distance of lithium ions. Such gradient of lithium concentration becomes steeper particularly when a thickness of the negative active material layer is 200 μm or larger. Accordingly, the effect of placing metallic lithium between the negative active material layer and the current collector becomes particularly useful. However, the excessively large thickness of the negative electrode leads to a marked reduction in utilization factor thereof as an electrode plate. Therefore, preferably, the thickness of the negative active material layer is kept not to exceed 1,500 μm.

The molybdenum dioxide in the present invention is preferably comprised mainly of a stoichiometric composition of MoO₂. Inclusion of molybdenum oxide having a higher oxidation number, such as MoO_{2.25}, is very likely to lower the initial efficiency.

In the negative active material layer of the present invention, a graphitized vapor grown carbon fiber is preferably used as an electro conductor, which has a lattice constant C₀ in the range of 6.7 Å≦C₀≦6.8 Å and a ratio of dimensions (Lₐ and L_{c}) of crystallite both in the base plane (a plane) and in the stacking direction (c plane), Lₐ/L_{c}, in the range of 4≦Lₐ/L_{c}≦6. The use of such a graphitized vapor grown carbon fiber as an electro conductor prevents the electrolyte from decomposing on the electro conductor and accordingly improves the initial efficiency of the negative electrode.

A theoretical lower limit of a C₀ value for graphite material is 6.7 Å. Because a larger interlayer spacing of graphite is believed to accelerate a decomposition reaction of the electrolyte, C₀ preferably has a value of not exceeding 6.8 Å. Because a side reaction such as electrolyte decomposition is believe to take place mainly in the c plane but little in the a plane of the graphite material, the c plane is preferably less exposed. Accordingly, the Lₐ/L_{c} value may preferably be not smaller than 4. However, the larger Lₐ value increases an aspect ratio of the fiber configuration and deteriorates a forming performance of the electrode and a handling performance of the electrode mix. Therefore, the Lₐ/L_{c} value is preferably not larger than 6.

Also in the present invention, bulk artificial graphite having a lattice constant C₀ in the range of 6.7 Å≦C₀≦6.8 Å is preferably used in combination with the aforementioned vapor grown carbon fiber as the electro conductor. The use of such bulk artificial graphite in combination with the vapor grown carbon fiber results in the formation of the electrode which exhibits high strength, superior productivity and a high utilization factor. The blending proportion by weight of the vapor grown carbon fiber to the bulk artificial graphite (vapor grown carbon fiber: bulk artificial graphite) is preferably in the range of 50:50-100:0. If the amount of the bulk artificial graphite becomes excessively large, the initial efficiency may be lowered.

In the present invention, a lithium-containing transition metal oxide is preferably used as the positive active material.

A memory backup battery needs to show a working voltage in the same range as a driving voltage of a semiconductor to be backed up thereby. The negative active material can offer a battery which shows a working voltage in the approximate range of 3.0-2.0 V, when used as a negative electrode in combination with lithium cobaltate or the like.

Currently, the most popular backup secondary battery in the market is the one which is chargeable and dischargeable in the range of 3.0-2.0 V. As the positive active material which shows a charge-discharge potential meeting such a requirement, lithium cobaltate is most preferably used. In the case of lithium nickelate, a sufficient capacity can not be obtained even if a battery is discharged up to 2.0 V because its low charge-discharge potential lowers a discharge voltage of the battery. In the case of lithium manganate, a problem may arise in storage characteristics.

In the case where lithium cobaltate is used as the positive active material and the aforementioned active material as the negative active material, a utilization depth of lithium cobaltate is preferably in the range of 4.0-4.3 V (vs. Li/Li⁺) for the purpose of securing sufficient cycle characteristics. If it is in the range below 4.0 V (vs. Li/Li⁺), a sufficient specific capacity may not be obtained. On the other hand, if it is in the range higher than 4.3 V (vs. Li/Li⁺), a structure of the active material may become unstable to result in the failure to obtain sufficient cycle characteristics. Lithium cobaltate shows a specific capacity of about 100 mAh/g at a charge-discharge depth of 4.0 V (vs. Li/Li⁺) and about 165 mAh/g at a charge-discharge depth of 4.3 V (vs. Li/Li⁺). Molybdenum dioxide has a specific capacity of about 210 mAh/g and metallic lithium has a specific capacity of about 3,860 mAh/g.

From the foregoing, lithium cobaltate, molybdenum dioxide and metallic lithium when in use are desired to satisfy a relationship 100≦(210×W_{MoO2}−3,860×W_{Li})/W_{LCO}<165, where W_{LCO} is a weight of lithium cobaltate as the positive active material, W_{MoO2} is a weight of molybdenum dioxide for use as the negative active material and W_{Li} is a weight of metallic lithium placed against the negative electrode. If this condition is met, further improved cycle characteristics can be obtained.

In the present invention, a solvent for the nonaqueous electrolyte preferably contains 5-30% by volume of ethylene carbonate. If the amount of ethylene carbonate is below 5% by volume, a sufficient lithium-ion conducting property may not be obtained for the nonaqueous electrolyte. On the other hand, if ethylene carbonate is contained in the amount of exceeding 30% by volume, a decomposition product of ethylene carbonate may form a film on the negative active material in an excessive fashion to possibly deteriorate cycle characteristics. Other useful solvents for the nonaqueous electrolyte include cyclic carbonates such as propylene carbonate and butylene carbonate; and chain carbonates such as diethyl carbonate, ethyl methyl carbonate and dimethyl carbonate. Preferably, a mixed solvent containing cyclic and chain carbonates is used.

Examples of useful solutes for the nonaqueous electrolyte in the present invention include lithium hexafluorophosphate (LiPF₆), lithium borofluoride (LiBF₄), LiTFSI(LiN(CF₃SO₂)₂), LiBETI(LiN(C₂F₅SO₂)₂) and the like.

The method of the present invention for fabrication of a nonaqueous electrolyte secondary battery is a method by which the nonaqueous electrolyte secondary battery of the present invention can be fabricated. Characteristically, metallic lithium is placed in such a position as to contact a negative active material layer containing molybdenum dioxide (MoO₂) and, while they are in such an arrangement, a nonaqueous electrolyte is poured into a battery to thereby allow lithium to react to molybdenum dioxide (MoO₂) so that molybdenum dioxide is rendered into a lithium-containing molybdenum oxide represented by the chemical formula LiₓMoO₂ (0.05≦x≦0.25).

### EFFECT OF THE INVENTION

In accordance with the present invention, a nonaqueous electrolyte secondary battery can be provided which exhibits a high battery capacity and superior cycle characteristics on over discharge.

### BRIEF DESCRIPTION OF THE DRAWINGS

FIG. 1 is a schematic sectional view which shows a nonaqueous electrolyte secondary battery made in Examples in accordance with the present invention;

FIG. 2 is a graph which shows a relationship between number of cycles and capacity retention for batteries of Examples 1 and 2 in accordance with the present invention and Comparative Example 1, when they are cycled normally;

FIG. 3 is a graph which shows a relationship between number of cycles and capacity retention for batteries of Examples 1 and 2 in accordance with the present invention and Comparative Example 1, when they are cycled on over discharge; and

FIG. 4 is a graph which shows a relationship between battery discharge depth and amount of molybdenum dissolved.

### DESCRIPTION OF THE PREFERRED EXAMPLES

### Experiment 1

### Example 1

### Fabrication of Positive Electrode

LiCoO₂, acetylene black, artificial graphite and polyvinylidene fluoride (PVdF) in the ratio by weight of 88.8:5:5:1.2 were mixed in an N-methyl-pyrrolidone (NMP) solvent, dried and then pulverized to obtain a cathode mix.

25.8 mg of the cathode mix was metered, introduced in a molding jig having a diameter of 4.16 mm and then pressed at 600 kg·f to fabricate a disk-shaped positive electrode.

### Fabrication of Negative Electrode

MoO₂ as an active material, a graphitized vapor grown carbon fiber (C₀=6.80 Å, Lₐ=900 Å and L_{c}=200 Å), bulk artificial graphite (C₀=6.72 Å, Lₐ=300 Å and L_{c}=300 Å) and polyvinylidene fluoride (PVdF) as a binder were mixed in the ratio by weight of 87.5:5:2.5:5, dried and then pulverized to obtain an anode mix.

16.9 mg of the anode mix was metered, introduced in a molding jig having a diameter of 4.16 mm and then pressed at 600 kg·f to fabricate a disk-shaped negative electrode.

### Preparation of Electrolyte Solution

1 mole/liter of lithium hexafluorophosphate (LiPF₆) as a solute was dissolved in a mixed solvent containing ethylene carbonate (EC) and diethyl carbonate (DEC) at a 3:7 ratio by volume to prepare a nonaqueous electrolyte.

### Assembly of Battery

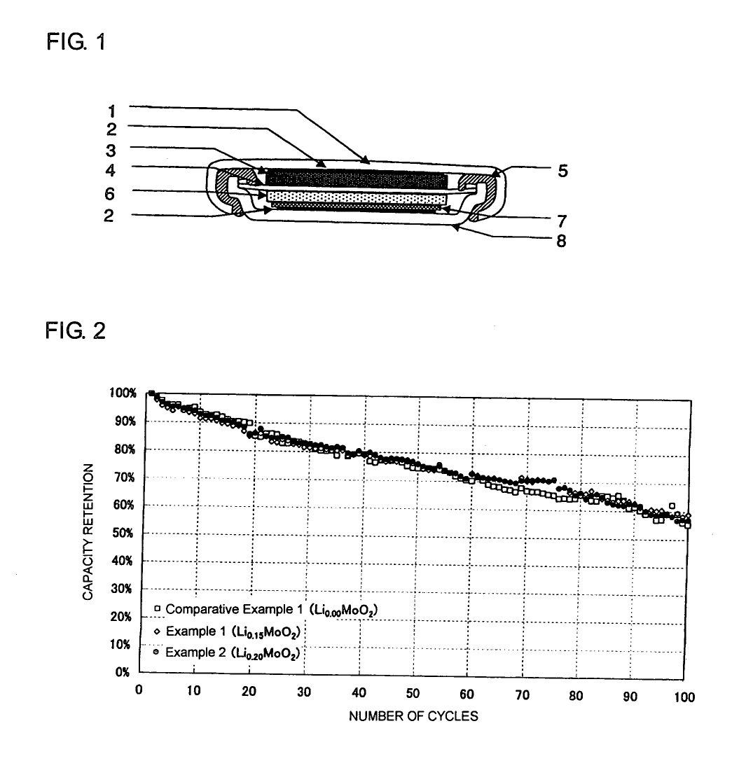

The thus-obtained positive electrode, negative electrode and nonaqueous electrolyte were used to fabricate a flat-type nonaqueous electrolyte secondary battery A1 (battery size: 6 mm in diameter and 1.4 mm in thickness). FIG. 1 is a schematic sectional view which shows the nonaqueous electrolyte secondary battery fabricated. As shown in FIG. 1, a positive electrode 3 and a negative electrode 6 are spaced from each other by a separator 4. Metallic lithium 7, weighing 0.12 mg, is placed in contact with the negative electrode 6 and flanked between the negative electrode and a negative can 8 as a negative current collector. The positive electrode 3 and the negative electrode 6 are enclosed in an interior space defined by a positive can 1 and the negative can 8. An electrically conductive carbon paste 2 connects the positive electrode 3 to the positive can 1, as well as connecting the negative electrode 6 and the metallic lithium 7 to the negative can 8. A polypropylene gasket 5 makes a joint between an outer peripheral surface of the negative can 8 and an inner peripheral surface of the positive can 1. The separator 4 comprises a polyphenylene sulfide nonwoven fabric. The above-prepared nonaqueous electrolyte is impregnated in the positive electrode 3, negative electrode 6 and separator 4.

After assembly of the battery having the above-described construction, the negative active material after diffusion of lithium but before charge and discharge is represented by a composition Li_{0.15}MoO₂.

### Example 2

The amounts of the cathode mix and anode mix were changed to 25.2 mg and 17.5 mg, respectively. Metallic lithium 7, weighing 0.17 mg, was placed in contact with the negative electrode 6. Otherwise, the procedure of Example 1 was followed to fabricate a nonaqueous electrolyte secondary battery A2.

After assembly of the battery having the above-described construction, the negative active material after diffusion of lithium but before charge and discharge is represented by a composition Li_{0.20}MoO₂.

### Comparative Example 1

The amounts of the cathode mix and anode mix were changed to 27.3 mg and 15.2 mg, respectively. The metallic lithium 7 was excluded. Otherwise, the procedure of Example 1 was followed to fabricate a nonaqueous electrolyte secondary battery X1.

After assembly of the battery having the above-described construction, the negative active material before charge and discharge is represented by a composition MoO₂.

### Evaluation of Charge-Discharge Characteristics

Each of the batteries obtained in the preceding Examples and Comparative Example was evaluated for initial charge-discharge characteristics, normal cycle characteristics and cycle characteristics on over discharge. The measurement conditions are listed below.

### Measurement Conditions for Initial Charge-Discharge Characteristics

Charge: constant current-constant voltage charging, 100 μA-3.2 V, 5 μA cutoff

Discharge: constant current discharging with multiple decreasing-current steps; 100 μA, 50 μA, 30 μA, 10 μA, 5 μA-2.0 V cutoff

Rest: 10 seconds

The initial charge capacity, initial discharge capacity and initial efficiency of each battery, when measured using the above conditions, are shown in Table 1. They are related to each other by (initial efficiency)=(initial discharge capacity)/(initial charge capacity)×100 (%).

TABLE 1

| | | Initial | | |
|---|---|---|---|---|
| | | Charge | | Initial |
| | | Capacity | Initial Discharge | Efficiency |
| | | (mAh) | Capacity (mAh) | (%) |
| Ex. 1 | Battery A1 | 2.76 | 2.59 | 94.0 |
| Ex. 2 | Battery A2 | 2.77 | 2.59 | 93.5 |
| Comp. Ex. 1 | Battery X1 | 3.03 | 2.51 | 82.8 |

### Measurement Conditions for Normal Cycle Characteristics

Charge: constant current charging, 100 μA, 3.2 V cutoff

Discharge: constant current discharging, 100 μA, 2.0 V cutoff

Rest: 10 seconds

The discharge capacity retention of each battery on each cycle during normal cycling, when measured using the above-specified conditions, is shown in FIG. 2.

As shown in FIG. 2, neither a marked decline of lithium concentration in the negative electrode plate nor a potential build-up of the negative electrode occurred during the normal cycling in the voltage range of 3.0-2.0 V. Accordingly, a substantial difference was not found between the battery of Comparative Example 1 and the batteries of Examples 1 and 2.

### Measurement Conditions for Cycle Characteristics on Over discharge

Charge: constant current charging, 100 μA, 3.2 V cutoff

Discharge: constant current discharging, 100 μA, 0.01 V cutoff

Rest: 10 seconds

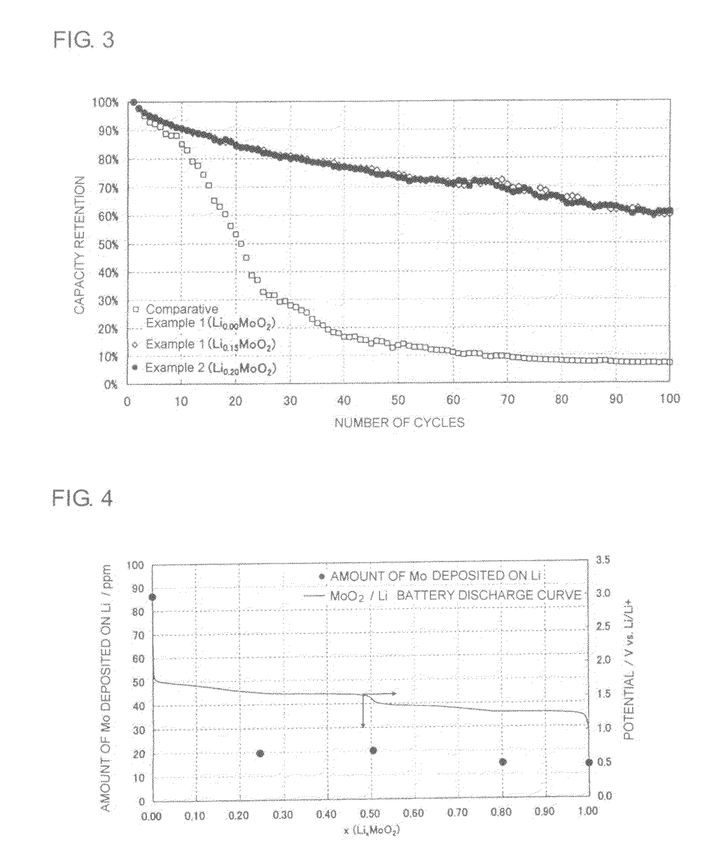

The discharge capacity retention of each battery for each cycle during cycling on over discharge, when measured using the above-specified conditions, is shown in FIG. 3.

As shown in FIG. 3, a rapid capacity decline occurred for the battery of Comparative Example 1 during cycling on over discharge. This is presumably because the occurrence of a marked decline of lithium concentration in the negative electrode and a potential buildup of the negative electrode allows Mo to dissolve from the negative active material during cycling on over discharge and then deposit on a surface of the negative active material during charging for passivation.

The batteries of Examples 1 and 2 incorporating lithium in contact with the negative electrode were free from such a phenomenon and accordingly exhibited markedly improved cycle characteristics on over discharge.

### Experiment 2

The backup battery is required to not only show a good cycling performance on over discharge that occurs when a power supply from a main battery is terminated, but also exhibit superior storage characteristics in charged state because it is always kept in a fully charged state when a power supply from the main battery continues. In Experiment 2, the following procedures were utilized to evaluate storage characteristics in charged state for the batteries fabricated in Experiment 1.

### Example 3

The procedure of Example 1 was followed to fabricate a flat-type lithium secondary battery A3.

### Example 4

The procedure of Example 2 was followed to fabricate a flat-type lithium secondary battery A4.

### Comparative Example 2

The procedure of Comparative Example 1 was followed to fabricate a flat-type lithium secondary battery X2.

### Storage Characteristics in Charged State

Subsequent to measurement of initial charge-discharge characteristics, each battery was charged using the same conditions as those for the initial charging and then stored in a constant-temperature tank maintained at 60° C. for 20 days. An impedance at 1 kHz of the battery prior to and subsequent to storage was measured. The results are shown in Table 2 in terms of internal resistance of the battery.

TABLE 2

Internal Resistance
of Battery (Ω)

| | | Before Storage | After Storage |
|---|---|---|---|
| Ex. 3 | Battery A3 | 44.4 | 69.2 |
| Ex. 4 | Battery A4 | 43.6 | 73.4 |
| Comp. Ex. 2 | Battery X2 | 86.2 | 611.1 |

The battery X2 of Comparative Example 2 showed a marked increase of internal resistance after storage. On the other hand, such a marked internal resistance buildup after storage was suppressed in the batteries A3 and A4 of Examples 3 and 4 each incorporating metallic lithium between the anode mix layer and the current collector, as can be seen from the results.

Because molybdenum dioxide has a very high electrical conductivity on the order of 10² S·cm⁻¹, a potential distribution of the negative electrode in its thickness direction readily becomes uniform irrespective of the lithium concentration in the active material. This is assumed to ease insertion of lithium ions from a surface portion of the negative electrode that has a shorter transfer distance to the positive electrode and, as a result, create a concentration gradient of lithium in the negative electrode. Then, a part of molybdenum dioxide in the neighborhood of the current collector serves as a mere conductor and exists with an extremely low concentration of lithium.

However, the extremely low concentration of lithium in molybdenum dioxide increases the tendency of Mo to dissolve from molybdenum dioxide into the electrolyte, as described above.

The presence of such a concentration gradient in the electrode during storage at high temperature is presumed to increase an internal resistance of the battery, because it allows Mo to dissolve from a portion of the active material that is remoter from the positive electrode, i.e., closer to the current collector and lower in lithium concentration.

If metallic lithium is placed in contact with the anode mix layer containing the negative active material, as shown in the above Examples, lithium is allowed to diffuse into the anode mix layer when the electrolyte is poured in the battery. This is believed to have increased a lithium concentration of the negative electrode in the neighborhood of the current collector and accordingly solved the above-described problems.

### Reference Experiments

### Reference Experiment A

Molybdenum dioxide, a vapor grown carbon fiber and PVdF in the ratio by weight of 90:5:5 were mixed in an NMP solvent to provide a slurry. This slurry was applied onto an Al foil, dried and then compressed to fabricate an electrode plate. A mix layer comprising the above mixture, weighing 11.9 mg/cm², was incorporated in the electrode plate. The electrode plate was then cut to provide a 2.0×2.0 cm rectangular electrode plate. This electrode plate, a microporous polyethylene film as a separator and metallic lithium as a counter electrode were enclosed in an aluminum laminated casing into which a nonaqueous electrolyte (1 M (mol/liter) LiPF₆ EC/DEC=3/7) was poured to complete fabrication of a nonaqueous electrolyte secondary battery. This battery was stored at 60° C. for 5 days. Then, the amount of an Mo element precipitated on the lithium counter electrode was determined using ICP. The ratio by amount of the Mo element dissolved to the Mo element contained in the electrode plate before storage was 86.3 ppm.

### Reference Experiment B

The same battery as used in Reference Experiment A was discharged to 1.6 V. The discharge depth was recorded as x≈0.25 for LiₓMoO₂. The discharged battery was stored at 60° C. for 5 days. Then, the amount of an Mo element precipitated on the lithium counter electrode was determined using ICP. The ratio by amount of the Mo element dissolved to the Mo element contained in the electrode plate before storage was 19.7 ppm.

### Reference Experiment C

The same battery as used in Reference Experiment A was discharged to 1.5 V. The discharge depth was recorded as x≈0.50 for LiₓMoO₂. The discharged battery was stored at 60° C. for 5 days. Then, the amount of an Mo element precipitated on the lithium counter electrode was determined using ICP. The ratio by amount of the Mo element dissolved to the Mo element contained in the electrode plate before storage was 20.4 ppm.

### Reference Experiment D

The same battery as used in Reference Experiment A was discharged to 1.3 V. The discharge depth was recorded as x≈0.80 for LiₓMoO₂. The discharged battery was stored at 60° C. for 5 days. Then, the amount of an Mo element precipitated on the lithium counter electrode was determined using ICP. The ratio by amount of the Mo element dissolved to the Mo element contained in the electrode plate before storage was 14.8 ppm.

### Reference Experiment E

The same battery as used in Reference Experiment A was discharged to 1.0 V. The discharge depth was recorded as x≈1.00 for LiₓMoO₂. The discharged battery was stored at 60° C. for 5 days and then the amount of an Mo element precipitated on the lithium counter electrode was determined using ICP. The ratio by amount of the Mo element dissolved to the Mo element contained in the electrode plate before storage was 14.1 ppm. A relationship between the discharge capacity of molybdenum dioxide and the amount of the Mo element precipitated on the metallic lithium counter electrode, as obtained from the above Experiments, is shown in FIG. 4.

As can be seen from the comparison between Reference Experiments A-E, the tendency of Mo to dissolve from molybdenum dioxide increases particularly when a lithium concentration in the electrode plate is low, which is shown in FIG. 4. Also, Mo once dissolved precipitates on a portion having a lower potential such as on metallic lithium.

What is claimed is:

1. A nonaqueous electrolyte secondary battery including a positive electrode containing lithium-containing transition metal oxide as a positive active material, a negative electrode containing a negative active material and a nonaqueous electrolyte, said negative active material comprising lithium-containing molybdenum oxide represented by the chemical formula LiₓMoO₂ (0.05≦x≦0.25) when in a fully discharged state.

2. The nonaqueous electrolyte secondary battery as recited in claim 1, wherein said negative active material is obtained by allowing lithium to react to molybdenum dioxide (MoO₂) electrochemically.

3. The nonaqueous electrolyte secondary battery as recited in claim 2, wherein lithium is allowed to react to molybdenum dioxide (MoO₂) by placing metallic lithium in such a position as to contact a negative active material layer containing molybdenum dioxide (MoO₂) and, while they are in such an arrangement, pouring said nonaqueous electrolyte into a battery.

4. The nonaqueous electrolyte secondary battery as recited in claim 3, wherein said negative electrode includes a current collector and said metallic lithium is interposed between the negative active material layer and said current collector.

5. The nonaqueous electrolyte secondary battery as recited in claim 4, wherein a thickness of said negative active material layer is not less than 200 μm.

6. A method for fabrication of the nonaqueous electrolyte secondary battery as recited in claim 3, wherein metallic lithium is placed in such a position as to contact the negative active material layer containing molybdenum dioxide (MoO₂) and, while they are in such an arrangement, said nonaqueous electrolyte is poured into a battery to thereby allow lithium to react to molybdenum dioxide (MoO₂) so that said lithium-containing molybdenum oxide represented by the chemical formula LiₓMoO₂ (0.05≦x≦0.25) is formed.

7. A method for fabrication of the nonaqueous electrolyte secondary battery as recited in claim 4, wherein metallic lithium is placed in such a position as to contact the negative active material layer containing molybdenum dioxide (MoO₂) and, while they are in such an arrangement, said nonaqueous electrolyte is poured into a battery to thereby allow lithium to react to molybdenum dioxide (MoO₂) so that said lithium-containing molybdenum oxide represented by the chemical formula LiₓMoO₂ (0.05≦x≦0.25) is formed.

8. A method for fabrication of the nonaqueous electrolyte secondary battery as recited in claim 5, wherein metallic lithium is placed in such a position as to contact the negative active material layer containing molybdenum dioxide (MoO₂) and, while they are in such an arrangement, said nonaqueous electrolyte is poured into a battery to thereby allow lithium to react to molybdenum dioxide (MoO₂) so that said lithium-containing molybdenum oxide represented by the chemical formula LiₓMoO₂ (0.05≦x≦0.25) is formed.
